(19) United States
(12) Patent Application Publication
(10) Pub. No.: US 2009/0066888 A1
(43) Pub. Date: Mar. 12, 2009

(54) COMPOSITE POLARIZING PLATE AND LIQUID CRYSTAL DISPLAY USING THE SAME

(75) Inventors: Yuichiro Kunai, Ehime (JP); Yoshiki Matsuoka, Ehime (JP); Hideo Kuroiwa, Ehime (JP); Tohru Nagashima, Ehime (JP); Yuuhei Inokuchi, Ehime (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, CHUO-KU, TOKYO (JP)

(21) Appl. No.: 12/298,593

(22) PCT Filed: Apr. 24, 2007
(86) PCT No.: PCT/JP2007/059347

§ 371 Date: Oct. 27, 2008

(30) Foreign Application Priority Data
Apr. 28, 2006 (JP) 2006-125008

(51) Int. Cl. G02F 1/1335; G02B 1/08

(52) U.S. Cl. 349/96; 359/500

(57) ABSTRACT

Disclosed is a composite polarizing plate wherein a transparent protection layer (40) is formed on one side of a polarizer (30) which is composed of a polyvinyl alcohol resin and a retardation film (20) composed of a polypropylene resin is bonded to the other side of the polarizer (30), which is opposite to the side on which the transparent protection layer (40) is formed. The retardation film (20) composed of a polypropylene resin may be made of a homopolymer of propylene, or alternatively made of a copolymer with another monomer which mainly consists of propylene. A liquid crystal display is obtained by arranging this composite polarizing plate on at least one side of a liquid crystal cell (50).

### TECHNICAL FIELD

The present invention relates to a composite polarizing plate and a liquid crystal display using the same. More particularly, the present invention relates to a composite polarizing plate useful for providing a liquid crystal display excellent in a field angle property and a liquid crystal display using the same.

### BACKGROUND ART

In recent years, lightweight and thin flat liquid crystal displays being low-consumption of electric power and operable at low voltage have rapidly become popular as display devices for information such as mobile phones, portable information terminals, monitors for computers, televisions, or the like. Along with developments of liquid crystal techniques, liquid crystal displays of various modes have been proposed and problems of liquid crystal displays such as response speed, contrast, and a narrow field angle have been resolved. However, it has been still pointed out that a field angle as compared with that of cathode ray tubes (CRT) is narrow and various approaches have been carried out to widen the field angle.

As one of such liquid crystal displays, there is a liquid crystal display of a vertical alignment (VA) mode in which rod-like liquid crystal molecules having a positive or a negative dielectric constant anisotropy are aligned vertically to a substrate. With respect to such a vertical alignment mode, in a non-operation state, since the liquid crystal molecules are aligned vertically to a substrate, light passes through a liquid crystal layer without being changed by polarization. Therefore, by providing linear polarizing plates above and below a liquid crystal panel in a manner that their polarization axes are set to be mutually rectangular, almost complete black display can be obtained by viewing from the front, and high contrast ratio can be obtained.

However, in the case of the liquid crystal display of the VA mode equipped with merely the polarizing plates for liquid crystal cells, when the liquid crystal display is viewed slantingly, due to the fact that the axial angle of the provided polarizing plates is shifted from 90°, and that the birefringence is caused by the rod-like liquid crystal molecules in the cells, light leakage is generated and the contrast ratio is considerably lowered.

To solve such light leakage, by providing a retardation film between liquid crystal cells and polarizing plates for optical compensation, the light leakage at the time of slanting viewing needs to be suppressed. So far, composite polarizing plates by sticking retardation films to polarizing plates, which has a protection layer composed of a triacetyl cellulose film on both sides of a polarizer, with a pressure sensitive adhesive interposed therebetween have been commercialized.

Recently, those having a constitution in which a protection layer of a polarizing plate has a function as a retardation film have been commercialized. With such a constitution, since one layer of a triacetyl cellulose film, the protection layer, and one pressure sensitive adhesive layer can be reduced, the cost can be saved and the thickness can be made thin and by selecting a retardation film with low photoelastic coefficient for use, there is an advantage that display failure, so-called blanking, can be suppressed. Further, by selecting a retardation film with low moisture permeability for use, it is possible that change in dimension due to moisture absorption and desorption of the polarizing plate itself is suppressed and the display failure is lowered.

As specific examples of known documents, JP Nos, 8-43812A and 9-325216A disclose that at least one of protection layers of a polarizer is composed of a birefringence film. Further, JP-A Nos. 7-287123 and 2002-221619 disclose that protection layers of a polarizer is composed of a norbornene resin with low photoelastic coefficient and low moisture permeability.

Herein, in the case where a birefringence film is used as a protection layer of a polarizing plate, the photoelasticity and the oriented birefringence are said to have substantially no correlation; however when materials with a low photoelastic coefficient are selected to suppress blanking, there occur problems that it becomes difficult to exhibit retardation at the time of stretching in many materials, and that only a thick film has to be used to exhibit desired retardation value, and the like. On the other hand, when materials with low moisture permeability are selected to suppress change in dimension of a polarizing plate due to moisture absorption and desorption, there occur problems that the adhesive property is often worse and desired adhesive force cannot be obtained.

### DISCLOSURE OF THE INVENTION

Here, in the case where a birefringence film is used as a protection layer of a polarizing plate, the photoelasticity and the oriented birefringence are said to have substantially no correlation; however when materials with low photoelastic coefficient are selected to suppress blanking, it becomes difficult to exhibit retardation at the time of stretching in many materials and only a thick film is used to exhibit desired retardation value. On the other hand, if materials with low moisture permeability are selected to suppress change in demension of a polarizing plate due to moisture absorption and desorption, the adhesive property is often worse and desired adhesive force cannot be obtained in some cases.

The inventors have made investigations to develop a composite polarizing plate in which a retardation film is adhered to one face of a polarizer, which is excellent in size stability, made thin in the thickness and has good adhesion property. As a result, the inventors have found that if a polypropylene resin film is used as a retardation film to be stuck to a polarizer, photoelastic coefficient can be suppressed sufficiently, a thickness is also made thin and moisture permeability is low and adhesion property to the polarizer can be made good and accordingly, the inventors have completed the invention.

Consequently, it is an object of the invention to provide a composite polarizing plate excellent in the size stability, capable of exhibiting desired retardation value with a thin thickness, and having good adhesion property between a polarizer and a retardation film. It is another object of the invention to use this composite polarizing plate for a liquid crystal display.

According to the invention, a composite polarizing plate including a transparent protection layer on one face of a polarizer made of a polyvinyl alcohol resin, and in which a retardation film made of a polypropylene resin is adhered to the other face of the polarizer opposite to the transparent protection layer is provided. The retardation film made of a polypropylene resin is not limited to propylene homopolymers, and may be copolymers with another monomer containing mainly propylene.

Further, according to the invention, a liquid crystal display in which this composite polarizing plate is laminated at least one side of a liquid crystal cell is also provided.

### BRIEF DESCRIPTION OF THE DRAWINGS

FIG. 1: A perspective view schematically showing a constitution of a composite polarizing plate according to the invention.

FIG. 2: A perspective view schematically showing a constitution example of a composite polarizing plate used for a liquid crystal display and it also represents a constitution of Example 3.

FIG. 3: An equivalent contrast curve showing field angle property when a composite polarizing plate of the invention is mounted on a liquid crystal panel in Example 3.

FIG. 4: An equivalent contrast curve showing field angle property of a liquid crystal television itself (before disassembly) used in Example 3.

### EXPLANATION OF REFERENCE NUMERALS

10 . . . composite polarizing plate
20 . . . retardation film made of a polypropylene resin film
22 . . . retardation axis of retardation film
30 . . . polarizer
32 . . . absorption axis of polarizer
40 . . . transparent protection layer
50 . . . liquid crystal cell
52 . . . longitudinal direction of liquid crystal cell

### BEST MODES FOR CARRYING OUT THE INVENTION

Hereinafter, embodiments of the invention will be described in detail. In the present invention, a retardation film made of a polypropylene resin is adhered to the opposite side to a transparent protection layer of a polarizer having the transparent protection layer on one face to obtain a composite polarizing plate.

### (Composite Polarizing Plate)

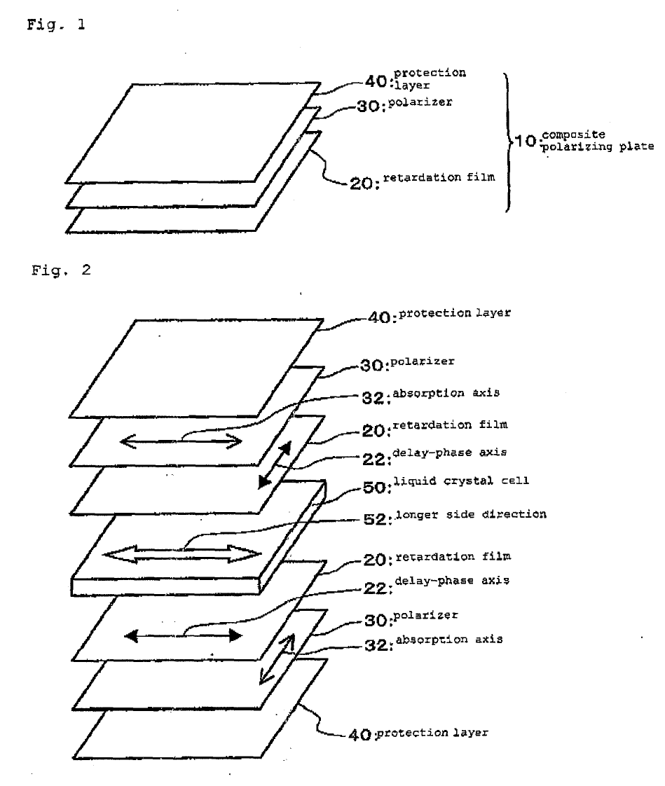

A layer constitution of a composite polarizing plate of the invention is shown in FIG. 1 as a schematic perspective view in which the respective layers are parted. As shown in this Fig., a composite polarizing plate 10 of the invention is a plate in which a transparent protection layer 40 is provided on one face of a polarizer 30 and a retardation film 20 made of a polypropylene resin film is disposed on the other face of the polarizer 30 opposite side to the transparent protection layer 40.

The polarizer 30 may be the one which is made of polyvinyl alcohol resins and is commonly employed in this field. Specifically, usable ones are linear polarizers provided with a function of absorbing linear polarized light having a vibration face in a certain direction and transmitting linear polarized light having a vibration face rectangular to the former direction by adsorbing and aligning a dichroic dye in the polyvinyl alcohol resins. As the dichroic dye, iodine and a dichroic organic dye can be used. Such a polarizer can be obtained by uniaxially stretching a polyvinyl alcohol resin film, dyeing with a dichroic dye, and treating with boric acid after the dyeing.

It is advantageous that the transparent protection layer 40 provided on one face of the polarizer 30 is constituted with, for example, an acetyl cellulose resin film represented by triacetyl cellulose (TAC) and diacetyl cellulose commonly used as a protection layer of a polarizer conventionally, in addition, a cyclic polyolefin resin film represented by a norbornene resin and a polypropylene resin film may be used.

A retardation film 20 made of a polypropylene resin is formed on the other face of the polarizer 30. This retardation film 20 can be obtained by stretching a polypropylene resin film. The polypropylene resin is a resin mainly made of propylene units and is generally crystalline and is composed of a homopolymer of propylene or, is composed of a copolymer of mainly propylene and a small amount, for example about 20% by weight of another comonomer. Particularly, a propylene/ethylene copolymer obtained by copolymerizing ethylene to contain 10% by weight or less of ethylene units is one of preferable polypropylene resins.

### (Polypropylene Resin)

Herein, a reason for selecting the polypropylene resin as a resin for composing the retardation film 20 will be described. While a bisphenol A polycarbonate which has conventionally widely been used for the retardation film is excellent in generating the retardation by stretching, since the photoelastic coefficient is as high as about 27×10⁻¹³ cm²/dyne, uneven sticking or blanking occurs easily at the time of sticking. On the other hand, triacetyl cellulose which has conventionally been used widely for a protection layer of a polarizer is excellent in adhesion property to a polarizer; however the photoelastic coefficient is as high as about 13×10⁻¹³ cm²/dyne and also the development of the retardation by stretching is small. Therefore, cases of using a retardation film obtained by stretching a triacetyl cellulose film are not found so much. Further, since a triacetyl cellulose film also has high moisture permeability, it is pointed out that a polarizing plate using the film as a protection layer in the pressure sensitive adhesive side has high change in dimension due to moisture absorption and it results in a cause of blanking. Whereas the norbornene resins (representative ones are “Zeonor” sold by Zeon Corporation, Ltd. and “Arton” sold by JSR Corporation) described in the JP-A Nos. 7-287123 and 2002-221619 have photoelastic coefficient as low as about 4×10⁻¹³ cm²/dyne and are thus effective for suppressing uneven sticking or blanking; the retardation is hardly exhibited even by stretching and therefore, in order to obtain desired retardation, certain degree of thickness is needed. Further, a norbornene resin film also has a problem in terms of adhesion property to a polarizer made of a polyvinyl alcohol resin.

On the other hand, a polypropylene resin has photoelastic coefficient as low as about 2×10⁻³ cm²/dyne and also has low moisture permeability. Further, the retardation can be exhibited easily by stretching and further unexpectedly, adhesion property to a polarizer made of a polypropylene resin film is good although it is not so high as that of a triacetyl cellulose film and in the case of using conventionally known various kinds of adhesives, it is found that the polypropylene resin film can be adhered to a polarizer made of a polyvinyl alcohol resin with sufficiently high strength. From such reasons, the retardation film provided on one face of a polarizer is to be composed of a polypropylene resin.

The polypropylene resin can be produced by a method of homo-polymerizing propylene and a method of copolymerizing propylene and another co-polymerizable comonomer using a conventionally known catalyst for polymerization. The conventionally known catalyst for polymerization may include, for example, as follows:

(1) a Ti—Mg catalyst of a solid catalyst component containing magnesium, titanium, and halogens as essential components;
(2) a catalyst system combined a solid catalyst component containing magnesium, titanium, and halogens as essential components with an organoaluminum compound and if necessary, a third component such as an electron donating compound; and
(3) a metallocene catalyst.

Among these catalyst systems, in the production of a polypropylene resin used for the retardation film in the invention, those combined a solid catalyst component containing magnesium, titanium, and halogens as essential components with an organoaluminum compound and an electron donating compound are most commonly usable. More specifically, preferable examples of the organoaluminum compound include triethylaluminum, triisobutylaluminum, a mixture of triethylaluminum and diethylaluminum chloride, tetraethyldialumoxane, and the like and preferable examples of the electron donating compound include cyclohexylethyldimethoxysilane, tert-butylpropyldimethoxysilane, tert-butylethyldimethoxysilane, dicyclopentyldimethoxysialne, and the like.

On the other hand, examples of the solid catalyst component containing magnesium, titanium, and halogens as essential components include catalyst systems described in JP-A Nos. 61-218606, 61-287904, 7-216017, and the like and examples of the metallocene catalyst include catalyst systems described in Japanese Patent Nos. 2587251, 2627669, 2668732, and the like.

The polypropylene resin can be produced by a solution polymerization method using an inactive solvent represented by hydrocarbon compounds, for example, hexane, heptane, octane, decane, cyclohexane, methylcyclohexane, benzene, toluene, and xylene; a bulk polymerization method using a liquid-phase monomer as a solvent; a vapor-phase polymerization method of polymerizing a gaseous monomer as it is; or the like. The polymerization by these methods may be carried out in batch manner or continuous manner.

The tactility of the polypropylene resin may be any of isotactic, syndiotactic, and atactic. In the present invention, in terms of the heat resistance, syndiotactic or isotactic polypropylene resins are preferably usable.

The polypropylene resin to be used in the invention may be composed of a homopolymer of propylene and may be those obtained by copolymerizing mainly propylene and a small amount of, for example, 20% by weight or less and preferably 10% by weight or less of comonomers co-polymerizable with propylene. In the case of using a copolymer, the amount of a comonomer is preferably 1% by weight or more.

The comonomer to be copolymerized with propylene may include for example ethylene and α-olefins having 4 to 20 carbon atoms. In this case, specific examples of α-olefins include the following:
1-butene and 2-methyl-1-propene (all C₄);
1-pentene, 2-methyl-1-butene, 3-methyl-1-butene (all C₅);
1-hexene, 2-ethyl-1-butene, 2,3-dimethyl-1-butene, 2-methyl-1-pentene, 3-methyl-1-pentene, 4-methyl-1-pentene, and 3,3-dimethyl-1-butene (all C₆);
1-heptene, 2-methyl-1-hexene, 2,3-dimethyl-1-pentene, 2-ethyl-1-pentene, and 2-methyl-3-ethyl-1-pentene (all C₇);
1-octene, 5-methyl-1-heptene, 2-ethyl-1-hexene, 3,3-dimethyl-1-hexene, 2-methyl-3-ethyl-1-pentene, 2,3,4-trimethyl-1-pentene, 2-propyl-1-pentene, and 2,3-diethyl-1 butene (all C₈);
1-nonene (C₉); 1-decene (C₁₀); 1-undecene (C₁₁); 1-dodecene (C₁₂); 1-tridecene (C₁₃); 1-tetradecene (C₁₄); 1-pentadecene (C₁₅); 1-hexadecene (C₁₆); 1-heptadecene (C₁₇); 1-octadecene (C₁₈); 1-nonadecene (C₁₉); and the like.

Preferable examples among α-olefins are α-olefins having 4 to 20 carbon atoms, and specifically include such as 1-butene, 2-methyl-1-propene; 1-pentene, 2-methyl-1-butene, 3-methyl-1-butene; 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene; 1-heptene, 2-methyl-1-hexene, 2,3-dimethyl-1-pentene, 2-ethyl-1-pentene, 2-methyl-3-ethyl-1-pentene; 1-octene, 5-methyl-1-heptene, 2-ethyl-1-hexene, 3,3-dimethyl-1-hexene, 2-methyl-3-ethyl-1-pentene, 2,3,4-trimethyl-1-pentene, 2-propyl-1-pentene, 2,3-diethyl-1-butene; 1-nonene; 1-decene; 1-undecene; and 1-dodecene. In terms of copolymerizability, 1-butehen, 1-pentene, 1-hexene, and 1-octene are preferable and particularly 1-butene and 1-hexene are more preferable.

The copolymer may be a random copolymer or a block copolymer. Preferable examples of the copolymer include propylene/ethylene copolymers and propylene/1-butene copolymers. With respect to the propylene/ethylene copolymers and propylene/1-butene copolymers, the content of the ethylene unit or the content of 1-butene unit may be measured by carrying out, for example, infrared (IR) spectrometry according to a method described in page 616 of “Polymer Analysis Handbook” (published by Kinokuniya Shoten, 1995).

In terms of improvement of transparency and processability as a retardation film to be laminated to a polarizer, it is preferable to use a random copolymer of mainly propylene and an unsaturated hydrocarbon. Among them, copolymers with ethylene are preferable. In the case of a copolymer, it is advantageous to set the copolymerization ratio of the unsaturated hydrocarbons other than propylene to be about 1 to 10% by weight and a more preferable copolymerization ratio is 3 to 7% by weight. An effect of increasing the processability and transparency tends to be exhibited by setting the ratio of the unsaturated hydrocarbons unit other than propylene to be 1% by weight or more. However, while the ratio exceeds 10% by weight, the melting point of the resin lowers and heat resistance tend to be deteriorated and therefore, it is not preferable. Here, in the case where the copolymer is that of two or more kinds of comonomers and polypropylene, the total content of the units derived from all of the comonomers contained in the copolymer is preferably in the above range.

The polypropylene resin used in the invention preferably has a melt flow rate (MFR) measured at 230° C. and a load of 21.18 N according to JIS K 7210 in a range of 0.1 to 200 g/10 minutes and particularly in a range of 0.5 to 50 g/10 minutes. Use of a polypropylene resin having MFR in this range makes it possible to obtain a uniform film-like product without burden an extruder.

The polypropylene resin may be blended with conventionally known additives to an extent that the effects of the invention are not suppressed. Examples of the additives include an antioxidant, an ultraviolet absorbent, an antistatic agent, a lubricant, a nucleating agent, an anti-fogging agent, an anti-blocking agent and the like. The antioxidant may be, for example, a phenol antioxidant, a phosphorus antioxidant, a sulfur antioxidant, and a hindered amine photostabilizer and further a composite type antioxidant containing a unit having both mechanism preventing from phenol oxidation preventing mechanism and phosphorus oxidation may also be usable. The ultraviolet absorbent may include, for example, 2-hdyroxybenzophenone and hydroxyphenylbenzotriazole ultraviolet absorbents and benzoate ultraviolet blocking agents. The antistatic agent may be any type of polymer, oligomer, and monomer. The lubricant may include, for example, higher fatty acid amides such as erucic amide and oleic acid amide, higher fatty acids such as stearic acid and salts thereof. The nucleating agent may be, for example, a sorbitol nucleating agent, an organic phosphate nucleating agent, and a polymer nucleating agent such as polyvinylcycloalkanes. As the anti-blocking agent, for example, fine particles with spherical or almost spherical shape can be used regardless of inorganic or organic A plurality of kinds of these additives may be used in combination.

### (Raw Film of Polypropylene Resin)

A polypropylene resin is formed into a film by an method to obtain a raw film. This raw film is transparent and substantially has no in-plane retardation. For example, a raw film of a polypropylene resin substantially having no in-plane retardation can be obtained by an extrusion molding method using a molten resin, a solvent casting method of forming a film by pouring a resin dissolved in an organic solvent to a flat plate and removing the solvent, and the like.

A method for producing a raw film by extrusion molding will be described in detail. A polypropylene resin is melted and kneaded by rotation of a screw in an extruder and extruded in a sheet-like shape from a T die. The temperature of the extruded molten-state sheet is about 180 to 300° C. If the temperature of the molten-state sheet is under 180° C., the spreadability is not sufficient and the thickness of the film to be obtained becomes uneven and thus the film may possibly be uneven in retardation. In addition, if the temperature exceeds 300° C., the resin tends to be deteriorated or decomposed to generate foams in the sheet or include carbides in some cases.

The extruder may be a uniaxial extruder or a biaxial extruder. For example, in the case of a uniaxial extruder, usable are screws with a ratio L/D of length L and diameter D in a range of around 24 to 36, a compression ratio (former/latter) of space volume of a screw groove in a resin supply part and space volume of a screw groove in a resin measurement part in a range of around 1.5 to 4 and of types such as a full flight type, a barrier type and also a Madoc type having kneading part. In terms of suppression of deterioration and decomposition of polypropylene resin and evenness of melting and kneading, it is preferable to use screws of a barrier type having L/D in a range of 28 to 36 and a compression ratio of 2.5 to 3.5, Further, to suppress deterioration and decomposition of the polypropylene resin as much as possible, it is preferable to keep the inside of the extruder in nitrogen atmosphere or vacuum. Furthermore, to remove a volatile gas generated by deterioration or decomposition of the polypropylene resin, it is also preferable to provide an orifice of 1 mmφ or more and 5 mmφ or less at the tip end of the extruder to increase the resin pressure at the tip end part of the extruder. To increase the resin pressure to the orifice at the tip end part of the extruder means to increase the back pressure at the tip end and accordingly the stability of extrusion can be improved. The diameter of the orifice to be employed may be preferably 2 mmφ or more and 4 mmφ or less.

The T die used for extrusion is preferably a die which is free from slight steps or scratches on the flow channel surface of the resin and whose lip part is plated or coated with a material having a small friction coefficient with the melted polypropylene resin and further has a sharp edge-like shape polished to be 0.3 mmφ or less. Examples of materials with a small friction coefficient include tungsten carbide and fluoro specialized plating. Use of such a T die suppresses occurrence of eye discharges and at the same time suppresses die line formation, so that a resin film excellent in appearance uniformity can be obtained. This T die is preferable to have a manifold with a coat hunger shape and satisfy the following condition (1) or (2) and more preferable to satisfy the following condition (3) or (4):

(1) in the case where the lip width of the T die is less than 1500 mm: the length of the T die in the thickness direction >180 mm;
(2) in the case where the lip width of the T die is equal to or more than 1500 mm: the length of the T die in the thickness direction >220 mm;
(3) in the case where the lip width of the T die is less than 1500 mm: the length of the T die in the height direction >250 mm; and
(4) in the case where the lip width of the T die is equal to or more than 1500 mm: the length of the T die in the height direction >280 mm.

By using such a T die satisfying such conditions alligns the flow of molten-state polypropylene resin in order in the inside of the T die and also makes it possible to carry out extrusion with suppressed thickness unevenness even in the lip part and accordingly, a raw film excellent in the thickness precision and even retardation can be obtained.

In terms of suppression of the extrusion alteration of the polypropylene resins it is preferable to attach a gear pump between the extruder and the T die through an adaptor interposed therebetween. Further, to remove foreign matter contained in the polypropylene resin, it is also preferable to attach a leaf disk filter.

A molten-state sheet extruded out of the T die is cooled and solidified by pinching between a cooling roll made of a metal (also referred to a chill roll or a casting roll) and a touch roll including an elastic body rotating while being pressed against the cooling roll made of a metal in the circumferential direction to obtain a desired film. At that timer the touch roll may have the surface of the elastic body such as rubber as it is or may be an elastic body roll coated with an outer cylinder made of a metal sleeve on its surface. In the case of using a touch roll including an elastic body roll coated with an outer cylinder made of a metal sleeve on its surface, the molten-state sheet of the polypropylene resin is directly pinched between the cooling roll made of a metal and the touch roll to be cooled.

On the other hand, in the case of using a touch roll having the surface of an elastic body, a biaxially stretched film of a thermoplastic resin may be inserted between the molten-state sheet of the polypropylene resin and the touch roll tor pinch.

To carry out the cooling and solidification of the molten-state sheet of the polypropylene resin by pinching the sheet between the cooling roll and the touch roll as described above, it is required to quench the molten-state sheet by keeping the low temperatures the surface of both the cooling roll and touch roll. Specifically, the surface temperatures of both rolls are adjusted in a range of 0° C. or higher and 30° C. or lower. If these surface temperatures exceed 30° C., it takes a long time to cool and solidify the molten-state sheet and therefore the crystal components in the polypropylene resin are grown and it results in inferiority of the transparency of the film to be obtained. The surface temperatures of the rolls are preferably lower than 30° C. and more preferably lower than 250°. On the other hand, if the surface temperatures of the rolls are under 0° C., dewing occurs on the surface of the cooling roll made of a metal and droplets are deposited and accordingly the appearance of the film tends to be deteriorated.

With respect to the cooling roll made of a metal to be used, since the surface state of the roll is transferred to the surface of the polypropylene resin film, it may be possible to lower the thickness precision of the polypropylene resin film to be obtained in the case where the surface of the roll is uneven. Therefore, the surface of the cooling roll made of a metal is preferable to be specular as much as possible. Substantially, the surface roughness of the cooling roll made of a metal is preferably 0.3 S or lower and further preferably 0.1 S to 0.2 S by a standardized numeral series of the maximum height.

The touch roll forming the nip part with the cooling roll made of a metal preferably has the surface hardness of the elastic body in a range of 65 to 80 and more preferably 70 to 80 as a value measured by a spring type hardness test (A form) according JIS K 6301. Use of a rubber roll with such surface hardness makes it easy to keep the linear pressure applied to the molten-state sheet and also makes it easy to form a film without forming a bank (resin pool) of the molten-state sheet between the cooling roll made of a metal and the touch roll.

The pressure (linear pressure) at the time of pinching the molten-state sheet is determined by the pressing pressure of the touch roll to the cooling roll made of a metal. The linear pressure is preferably 50 N/cm or more and 300 N/cm or less and more preferably 100 N/cm or more and 250 N/cm or less. If the linear pressure is kept in the above range, the polypropylene resin film is produced easily without forming any bank while the linear pressure is kept constant.

In the case where a biaxially stretched film of a thermoplastic resin is pinched together with the molten-state sheet of the polypropylene resin between the cooling roll made of a metal and the touch roll, the thermoplastic resin constituting the biaxially stretched film may be a resin which is not thermally bonded firmly with the polypropylene resin and specific examples include polyesters, polyamides, poly(vinyl chloride), polyvinyl alcohols, ethylene-vinyl alcohol copolymers, and polyacrylonitriles. Among them, polyester which scarcely has change in dimension due to humidity, heat or the like is most preferable. In this case, the thickness of the biaxially stretched film is generally about 5 to 50 μm and is preferably 10 to 30 μA.

In this method, the distance from the lip of the T die to the point of pinching between the cooling roll made of a metal and the touch roll (air gap) is preferably 200 mm or less and more preferably 160 mm or less. The molten-state sheet extruded out of the T die is drawn in the gap from the lip to the rolls and tends to be aligned. It is made possible to obtain a film with less alignment by shortening the air gap as described above. The lower limit of the air gap is determined in accordance with the diameter of the cooling roll made of a metal and the diameter of the touch roll to be employed and also the tip end shape of the lip to be used and is generally 50 mm or more.

The processing speed at the time of producing the polypropylene resin film by this method is determined according to the time needed for cooling and solidifying the molten-state sheet. If the diameter of the cooling roll made of a metal to be used is wider, the distance of the molten-state sheet in contact with the cooling roll becomes long and therefore, the high speed production is made possible. Specifically, in the case of using the cooling roll made of a metal with a diameter of 600 mmφ, the processing speed is at maximum about 5 to 20 m/min.

The molten-state sheet pinched between the cooling roll made of a metal and the touch roll is cooled and solidified by the contact with the rolls. Thereafter, the side-end parts are slit if necessary, the sheet is wound by a winder to be a film. In this case, to protect the surface until the time of using the film, the film may be wound in a state that a surface protection film made of another thermoplastic resin is stuck to one or both faces of the film. In the case where the molten-state sheet of the polypropylene resin is pinched together with the biaxially stretched film made of a thermoplastic resin between the cooling roll made of a metal and the touch roll, the biaxially stretched film may be used as the surface protection film on one side.

### [Retardation Film]

The raw film of the polypropylene resin obtained in the above manner is stretched to develop retardation and obtain a retardation film. Particularly, a film provided with a birefringence property in biaxial directions by biaxial stretching is preferable. The stretching magnification in this case may be properly selected from a range about 1.1 to 10 times in the direction of developing the optical axis (the direction in which the stretching magnification is higher and the direction to be a phase-delay axis) and from a range about 1.1 to 7 times in the direction rectangular to the former (the direction in which the stretching magnification is lower and the direction to be a phase-advance axis) in accordance with the needed retardation value. The optical axis may be developed in the transverse direction of the film or the optical axis may be developed in the vertical direction.

To describe the retardation value of the retardation film 20, it is preferable that a in-plane retardation value (R0) is in a range of 40 to 500 nm and a retardation value in the thickness direction (Rth) is in a range of 20 to 500 nm. The retardation value may be properly selected from the ranges in accordance with the required characteristics for the liquid crystal display to be employed. The in-plane retardation value (R0) is more preferably 100 nm or less and the retardation value (Rth) in the thickness direction is preferably 80 nm or more and 300 nm or less.

The in-plane retardation value (R0) and the retardation value (Rth) in the thickness direction are defined by the following formulas (I) and (II), respectively:

R0=(nx−ny)×d (I) and

Rth=[(nx+ny)/2−nz]×d (II)

wherein nx denotes refractive index in the in-plane phase-delay axis direction; ny denotes refractive index in the in-plane phase-advance axis direction (direction rectangular to the phase-delay axis in plane); nz denotes refractive index in the thickness direction; and d denotes a thickness.

As descried above, the polypropylene resin easily exhibits the retardation by stretching and accordingly, the difference of nx and ny in the above formulas or the difference of nx or ny, and nz tends to be wide. Therefore, the stretched polypropylene resin film can exhibit desired retardation value by proper stretching even if the thickness d is made thin. The retardation film made of the polypropylene resin according to the invention is preferable to have a thickness of 60 μm or less. If it is too thin, the handling property is decreased, and accordingly, the thickness is preferably 5 μm or more. The thickness of the retardation film is more preferably 10 μm or more and 40 μm or less.

### (Adhesion of Retardation Film and Polarizer)

At the time of adhering the retardation film 20 made of the polypropylene resin film to the polarizer 30, the axial relation of both may be selectively in optimum in consideration of the field angle property and color change property in the liquid crystal display of interest. In the case of a large scale liquid crystal television for which the front contrast is thought to be important, the phase-delay axis of the retardation film 20 and the absorption axis of the polarizer 30 are often arranged almost in parallel or almost rectangular relation. Herein, “almost” in the phrases of almost in parallel or almost rectangular means preferably “parallel or rectangular” relation as described, however, it is allowable to include difference about ±10 degrees based on parallel or rectangular. The angular difference is more preferably ±5 degrees and even more preferably ±2 degrees.

For the adhesion of the retardation film 20 made of the polypropylene resin and the polarizer 30, for example, adhesives containing an epoxy resin, a urethane resin, a cyanoacrylate resin, an acrylamide resin or the like as a component can be employed and any of them can give good adhesion. From a viewpoint of thinning an adhesive layer, preferable adhesives may include water-based adhesives, that is, adhesives obtained by dissolving adhesive components in water or dispersing the adhesive components in water. Further, other preferable adhesives may include solvent-free adhesives, specifically, those which form adhesive layers by curing reaction of monomers or oligomers by heating or irradiating activen energy ray.

At first, water-based adhesives will be described. Examples of the adhesive components to be the water-based adhesives may include water-soluble crosslinkable epoxy resins, urethane resins, and the like.

Examples of the water-soluble crosslinkable epoxy resins may include polyamide epoxy resins obtained by causing reaction of polyamide polyamines, which are obtained by reaction of polyalkylenepolyamine such as diethylenetriamine and triethyleneteramine with dicarboxylic acids such as adipic acid, with epichlorohydrin. Commercialized products of such polyamide epoxy resins are “Sumirez Resin 650” and “Sumirez Resin 675” commercialized by Sumitomo Chemtex Co., Ltd.

In the case of using the water-soluble epoxy resins as the adhesive component, to improve the coatability and adhesive property, other water-soluble resins such as polyvinyl alcohol resins are preferably mixed. The polyvinyl alcohol resins may include partially saponified polyvinyl alcohol and completely saponified polyvinyl alcohol and additionally modified polyvinyl alcohol resins such as carboxyl group-modified polyvinyl alcohol, acetoacetyl group-modified polyvinyl alcohol, methylol group-modified polyvinyl alcohol, and amino group-modified polyvinyl alcohol. As proper commercialized products, “KL-318” (trade name), an anionic group-containing polyvinyl alcohol, commercialized by Kuraray Co. Ltd. can be exemplified.

In the case of using the adhesives containing water-soluble epoxy resins, adhesive solutions are prepared by dissolving the epoxy resins and other water-soluble resins such as polyvinyl alcohol resins if necessary. In this case, the concentration of the water-soluble epoxy resins is preferable to be about 0.2 to 2 parts by weight based on 100 parts by weight of water. Further, in the case where the polyvinyl alcohol resins are blended, the amount of the resins is preferably about 1 to 10 parts by weight and more preferably about 1 to 5 parts by weight to 100 parts by weight of water.

On the other hand, in the case of using water-soluble adhesives containing urethane resins, examples of proper urethane resins include ionomer type urethane resins, particularly polyester ionomer type urethane resins. Herein, ionomer type means those which are obtained by introducing a small amount of ionic components (hydrophilic components) into urethane resins constituting the skeleton. Further, the polyester ionomer type urethane resins may be urethane resins having polyester skeleton into which a small amount of ionic components (hydrophilic components) are introduced. Such ionomer type urethane resins are preferable as water-based adhesives since they can be emulsified to be emulsions directly in water with no need of using an emulsifier. Commercialized products of the polyester ionomer type urethane resins may be, for example, “Hydran AP-20”, “Hydran APX-101H”, and the like commercialized by DIC Corporation, and all of which are available as emulsions.

In the case of using ionomer type urethane resins as the adhesive component, it is preferable to additionally blend an isocyanate crosslinking agent. The isocyanate crosslinking agent is a compound having at least two isocyanato groups (—NCO) in a molecule and examples include monomers or oligomers such as 2,4-tolylene diisocyanate, phenylene diisocyanate, 4,4′-diphenylmethane diisocyanate, 1,6-hexamethylene dilsocyanate, isophorone diisocyanate, and adducts obtained by reaction of these compounds with polyols. Examples of commercialized isocyanate crosslinking agents to be used preferably are “Hydran Assister C-1” and the like commercialized boy DIC Corporation.

In the case of using water-based adhesives containing ionomer type urethane resins, in terms of the viscosity and adhesion property, those obtained by dispersing the urethane resins in water in a concentration of the urethane resins about 10 to 70% by weight, further 20% by weight or more and 50% by weight or less are preferable. In the case of blending the isocyanate crosslinking agent, the blending amount may be selected properly in a range of 5 to 100 parts by weight of the isocyanate crosslinking agent based on 100 parts by weight of the urethane resins.

The composite polarizing plate of the invention can be obtained by applying an adhesive as described above to the adhesive face(s) of the retardation film 20 made of the polypropylene resin and/or the polarizer 30 and to be stuck each other. Prior to the adhesion, it is also effective to improve the wettability of the surface of the retardation film 20 made of the polypropylene type resin by easy adhesion treatment such as corona discharge treatment. Further, after lamination, drying treatment may be carried out at a temperature of, for example, about 60 to 100° C. Thereafter, further it is preferable to carry out curing at a temperature slightly higher than room temperature, for example, 30 to 50° C. for 1 to 10 days in order to heighten the adhesion force more.

Next, solvent-free type adhesives will be described. Each solvent-free type adhesive does not contain significant amount of a solvent and is generally composed by containing a curable compound polymerizable by heating and irradiating an active energy ray and a polymerization initiator. In terms of the reactivity, those which are cured by cationic polymerization are preferable and particularly epoxy adhesives are preferably usable.

Accordingly, in one preferable embodiment of the composite polarizing plate of the invention, the retardation film made of the polypropylene type resin and the polarizer are adhered by a solvent-free epoxy type adhesive. This adhesive is preferable to be cured by cationic polymerization by heating or irradiating an active energy ray. Particularly, in terms of the weathering resistance and refractive index, an epoxy compound containing no aromatic ring is preferably usable as the curable compound. Adhesives using epoxy compounds containing no aromatic ring are described, for example, in JP-A No. 2004-245925. Examples of such epoxy compounds containing no aromatic ring include hydrides of aromatic epoxy compounds, alicyclic epoxy compounds, aliphatic epoxy compounds, and the like. The curable epoxy compounds used for the adhesives generally have two or more of epoxy groups in a molecule.

To describe the hydrides of aromatic epoxy compounds, the compounds are obtained by selectively carrying out hydrogenation reaction on aromatic rings of aromatic epoxy compounds under pressure in the presence of a catalyst. Examples of aromatic epoxy compounds are bisphenol type epoxy compounds such as diglycidyl ethers of bisphenol A, diglycidyl ethers of bisphenol F, and diglycidyl ethers of bisphenol S; novolak type epoxy resins such as phenol novolak epoxy resins, cresol novolak epoxy resins, and hydroxybenzaldehyde phenol novolak epoxy resins; and polyfunctional type epoxy compounds such as glycidyl ether of tetrahydroxydiphenylmethane, glycidyl ether of tetrahydroxybenzophenone, and epoxylated polyvinylphenol. Preferable examples of these aromatic epoxy compounds include hydrogenated bisphenol A diglycidyl ethers. Next, to describe the alicyclic epoxy compounds, they are compounds, as defined by the following formula, each having at least one epoxy group bonded to an alicyclic ring in a molecule

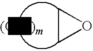

wherein m denotes an integer of 2 to 5.

The compounds in which the group obtained by removing one or a plurality of hydrogen atoms in (CH₂)ₘ in the above formula is bonded to other chemical configurations can be the alicyclic epoxy compounds. Further, hydrogen atoms of the alicyclic rings may be substituted properly with linear alkyl groups such as a methyl group and an ethyl group. Among them, compounds having an epoxycyclopentane ring (m=3 in the above formula) and an epoxycyclohexane ring (m=4 in the above formula) are preferable to be used. Specific examples of the alicyclic epoxy compounds are the followings: 3,4-epoxycyclohexylmethyl 3,4-epoxycyclohexane carboxylate, 3,4-epoxy-6-methylcyclohexylmethyl 3,4-epoxy-6-methylcyclohexane carboxylate, ethylenebis(3,4-epoxycyclohexane carboxylate), bis(3,4-epoxy cyclohexylmethyl) adipate, bis(3,4-epoxy-6-methycyclohexylmethyl) adipate, diethylene glycol bis(3,4-epoxycyclohexylmethyl ether), ethylene glycol bis(3,4-epoxycyclohexylmethyl ether) 2,3,14,15-diepoxy-7,11,18,21-tetraoxatrispiro-[5.2.2.5.2.2]heneicosane (a compound also named as 3,4-epoxycyclohexanespiro-2′,6′-dioxanespiro-3″,5″-dioxanes piro-3′″,4′″-epoxycyclohexane), 4-(3,4-epxoycyclohexyl)-2,6-dioxa-8,9-epoxyspiro[5.5]undecane, 4-vinylcyclohexene dioxide, bis-2,3-epoxycyclopentyl ether, dicyclopentadiene dioxide, and the like.

Next, to describe aliphatic epoxy compounds, the compounds are corresponding to polyglycidyl ethers of aliphatic polyhydric alcohols or their alkylene oxide adducts thereof. Examples of these compounds include diglycidyl ether of 1,4-butanediol, diglycidyl ether of 1,6-hexanediol, triglycidyl ether of glycerin, triglycidyl ether of trimethylolpropane, diglycidyl ether of polyethylene glycol, diglycidyl ether of polypropylene glycol, and polyglycidyl ethers of polyether polyols obtained by adding one or two or more kinds of alkylene oxides (ethylene oxide and propylene oxide) to aliphatic polyhydric alcohol such as ethylene glycol, polypropylene glycol, and glycerin.

These exemplified epoxy compounds may be used alone respectively and a plurality of the epoxy compounds may be used by mixing.

The epoxy equivalent of the epoxy compounds to be used for the solvent-free type adhesive is generally in a range of 30 to 3,000 g/equivalent and preferably in a range of 50 to 1,500 g/equivalent. If the epoxy equivalent is below 30 g/equivalent, the flexibility of the protection film after curing may possibly be lowered or the adhesion strength may possibly be decreased. On the other hand, if the epoxy equivalent exceeds 3,000 g/equivalent, the compatibility with other components may possibly be lowered.

To cure the epoxy compounds by cationic polymerization, a cationic polymerization initiator is blended. The cationic polymerization initiator generates cationic species or Lewis acid and starts polymerization reaction of epoxy group by irradiating an active energy ray such as visible light, ultraviolet ray, X-ray and electron beam or heating. Any type of cationic polymerization initiators is preferable to have latent property in terms of the workability.

Hereinafter, the photo-cationic polymerization initiators will be described. If a photo-cationic polymerization initiator is used, curing at normal temperature is made possible and the necessity of considering the heat resistance of the polarizer or strain due to expansion is lessened so that the retardation film and the polarizer can be stuck well. Further, since the photo-cationic polymerization initiator actions catalytically by light, even if it is mixed with an epoxy compound, it is excellent in storage stability and workability. Examples of compounds generating cationic species and Lewis acid by irradiating an active energy ray include onium salts such as aromatic diazonium salts, aromatic iodonium salts, and aromatic sulfonium salts and iron-allene complexes. Among them, since aromatic sulfonium salts have ultraviolet absorption property even in a wavelength range of 300 nm or longer, they are excellent in the curing property and capable of providing cured products with good mechanical strength and adhesion strength and therefore they are used preferably.

These photo-cationic polymerization initiators are easily available as commercialized products and examples include, under the trade names, such as “Kayarad PCI-220” and “Kayarad PCI-220” (both are manufactured by Nippon Kayaku Co., Ltd.), “UVI-6990” (manufactured by Union Carbide Corporation), “Adekaoptomer SP-150” and “Adekaoptomer SP-170” (both are manufactured by ADEKA Corporation), “CI-5102”, “CIT-1370”, “CIT-1682”, “CIP-1866S”, “CIP-2048S”, and “CIP-2064S” (all manufactured by Nippon Soda Co., Ltd.), “DPI-101”, “DPI-102”, “DPI-103”, “DPI-105”, “MPI-203”, “MPI-105”, “BBI-101”, “BBI-102”, “BBI-103”, “BBI-105”, “TPS-101”, “TPS-102”, “TPS-103”, “TPS-105”, “MDS-103”, “MDS-105”, “DTS-102”, and “DTS-103” (all manufactured by Midori Kagaku Co., Ltd.), “PI-2074” (manufactured by Rhodia Japan Ltd.). Particularly, “CI-5102” manufactured by Nippon Soda Co., Ltd. is one of preferable initiators.

The blending amount of the photo-cationic polymerization initiators is generally 0.5 to 20 parts by weight, preferably 1 part by weight or more and 15 parts by weight or less based on 100 parts by weight of the epoxy compounds.

Further, if necessary, a photosensitizer may be used in combination. Use of the photosensitizer improves the reactivity and the mechanical strength and the adhesion strength of cured products. Examples of the photosensitizer are carbonyl compounds, organic sulfur compounds, persulfides, redox compounds, azo and diazo compounds, halogen compounds, photo-reducing dyes and the like. In the case of blending the photosensitizer, the amount is about 0.1 to 20 parts by weight based on 100 parts by weight of a photo-cationic polymerizable epoxy resin composition.

Next, thermal cationic polymerization initiators will be described. Examples of compounds for generating cationic species or Lewis acid by heating include such as benzylsulfonium salts, thiophenium salts, thiolanium salts, benzylanmonium, pyridinium salts, hydrazinium salts, carboxylic acid esters, sulfonic acid esters, and aminimides. These thermal cationic polymerization initiators are also made available as commercialized products and examples include, under the trade names, such as “Adekaoptom CP77” and “Adekaoptom CP66” (both are manufactured by ADEKA Corporation), “CI-2639” and “CI-2624” (both are manufactured by Nippon Soda Co., Ltd.), “San-Aid SI-80L”, and “San-Aid SI-100L” (both are manufactured by Sanshin Chemical Industry Co., Ltd.).

Using in combination of the photo-cationic polymerization and thermal cationic polymerization described above is also a useful technique.

The epoxy adhesives may further contain compounds promoting the cationic polymerization such as oxetanes and polyols.

In the case of using a solvent-free adhesive, the adhesive may also be applied to the adhesion face of the retardation film and/or the polarizer and both are stuck to obtain a composite polarizing plate. A method for applying the solvent-free type adhesive to the retardation film or the polarizer is not particularly limited and for example, various application manners such as a doctor blade, a wire bar, a die coater, a comma coater, a gravure coater and the like can be employed. Further, since the respective application manners independently have optimum viscosity ranges, a small amount of a solvent may be used to adjust the viscosity. The solvent to be used for this may be those which can dissolve the epoxy adhesives well without lowering the optical capabilities of the polarizer and usable examples are organic solvents such as hydrocarbons represented by toluene and esters represented by ethyl acetate. In the case of using a solvent-free type epoxy adhesive, the thickness of the adhesive layer is generally 50 μm or less, preferably 20 μm or less, further preferably 10 μm or less and generally 1 μm or more.

After the retardation film of the polypropylene type resin is stuck to the polarizer through an uncured adhesive layer interposed therebetween as described above, the epoxy type adhesive layer is cured by irradiating the an active energy ray or heating to firmly fix the retardation film to the polarizer. In the case of curing by irradiating the active energy ray, ultraviolet rays are preferably used. Specific ultraviolet ray sources are low pressure mercury lamps, medium pressure mercury lamps, high pressure mercury lamps, black light lamps, metal halide lamps and the like. The irradiation intensity and dose of the an active energy ray or ultraviolet rays may be selected properly to an extent such that no adverse effect is caused on the adhesive layer after curing, the polarizer, the retardation film, and the transparent protection layer. Further, in the case of curing by heating, commonly known methods may be employed for heating and the temperature and the time in the case may also be selected properly to sufficiently activate the polymerization initiators and not to cause any adversed effect on the adhesive layer after curing, the polarizer, the retardation film, and the transparent protection layer.

For adhesion of the polarizer 30 and the transparent protection layer 40, adhesives same as described above may be used, or different adhesives may be employed; however it is preferable to use the same adhesive between the polarizer 30 and the retardation film 20 and between the polarizer 30 and the transparent protection layer 40 since steps and materials can be lessened.

It is made possible to stick the composite polarizing plate 10 composed in the above manner to liquid crystal cells by arranging a pressure sensitive type adhesive (pressure-sensitive adhesive) to the outside of the retardation film 20. The composite polarizing plate is laminated at least one sides of liquid crystal cells to constitute a liquid crystal display. The composite polarizing plate may be arranged on both faces of liquid crystal cells and the composite polarizing plate may be arranged in one faces of liquid crystal cells and another polarizing plate may be arranged on the other faces. To stick the composite polarizing plate 10 to the liquid crystal cells, the retardation film 20 side is provided so as to face the liquid crystal cells.

### (Liquid Crystal Display)

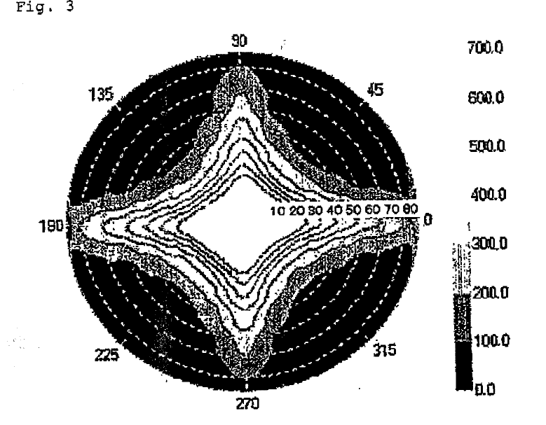

FIG. 2 shows a schematic perspective view of an example of arranging the composite polarizing plate of the invention in both faces of a liquid crystal cell. In this example, the respective layers are shown in parted state; however actually the respectively neighboring layers are firmly stuck. In the example shown in FIG. 2, a composite polarizing plate composed of a retardation film 20/a polarizer 30/a protection layer 40 is laminated to the lower side of the liquid crystal cell 50 in a manner that the retardation film 20 is set facing to the liquid crystal cell 50 and a composite polarizing plate having a retardation film 20/a polarizer 30/a protection layer 40 is also laminated to the upper side of the liquid crystal cell 50 in a manner that the retardation film 20 is set facing to the liquid crystal cell 50. In the respective composite polarizing plates, the delay-phase axis 22 of the retardation film 20 and the absorption axis 32 of the polarizer 30 are mutually rectangular and with respect to the polarizer 30 in the lower side, the absorption axis 32 is rectangular to the longer side direction 52 of the liquid crystal cell 50 and with respect to the polarizer 30 in the upper side, the absorption axis 32 is in parallel to the longer side direction 52 of the liquid crystal cell 50. A back light is disposed in the outside of the protection layer 40 of either one to give a liquid crystal display. In the case the liquid crystal cell is of a perpendicular alignment mode, this configuration is particularly effective.

Hereinafter, the invention will be described more in detail with reference to Examples; however the invention should not be limited to these Examples. Part(s) and % expressing use amounts and contents in Examples are on the basis of weight unless otherwise specified.

### EXAMPLE 1

### (a) Preparation of Adhesive

A water-based adhesive of the following composition was prepared. This was used as a water-based epoxy adhesive. Polyvinyl alcohol resin 3 parts

(“KL-318” made available by Kuraray Co., Ltd.)
Water-soluble polyamide epoxy resin 1.5 parts
(“Sumirez Resin 650” made available by Sumitomo Chemtex Co., Ltd., aqueous solution of 30% solid matter concentration) Water 100 parts

Further, another water-based adhesive of the following composition was prepared. This was used as a urethane type adhesive.

Polyester type ionomer urethane resin 30 parts
(“Hydran AP-20” made available by DIC Corporation, aqueous solution of 30% solid matter concentration)
Isocyanate type crosslinking agent 7.5 parts
(“Hydran Assister C-1” made available by DIC Corporation) Water 5 parts

Further, “Aron Alpha”, a cyanoacrylate type instant adhesive commercialized by Konishi Co., Ltd. was used as another adhesive.

Furthermore, as another adhesive, a solvent-free type epoxy ultraviolet curable adhesive containing an alicyclic epoxy compound and a photo-cationic polymerization initiator was used.

### (b) Production of Retardation Film

After a film of a propylene/ethylene random copolymer containing about 5% by weight of ethylene unit (Sumitomo Noblen W151, made available by Sumitomo Chemical Co., Ltd.) was produced, the film was successively stretched by biaxial stretching to obtain a biaxial retardation film. The retardation film had R0=65 nm and Rth=215 nm. To improve the wettability of the retardation film, corona discharge treatment was carried out for the surface.

### (c) Production of Composite Polarizing Plate

A polarizer comprising a protection layer of a triacetyl cellulose film stuck to one face of a polyvinyl alcohol/iodine type polarizer was prepared and the retardation film obtained in (b) was stuck to the polarizer face by the four types of the adhesives shown in (a). In the case the water-based epoxy adhesive or the urethane type adhesive was used, after the sticking, the adhesive was dried at 80° C. for 5 minutes and thereafter cured at 40° C. for about 60 hours. Further, in the case of using the epoxy ultraviolet curable adhesive, the adhesive was cured by irradiating ultraviolet rays in condition of output 1,000 mW and radiation dose 500 mJ from the polypropylene type resin film side using an ultraviolet irradiation system manufactured by Fusion UV Systems.

### (d) Evaluation of Adhesive

Each of the four type polarizing plates obtained as described in (c) was subjected to the separation strength of the polarizer and the retardation film by an almighty tensile tester. The samples using the water-based epoxy adhesive were subjected to a 180-degree separation test according to JIS K 6854-2:1999 and to a 90-degree separation test according to JIS K 6854-1:1999. The samples using the urethane type adhesive or the cyanoacrylate type instant adhesive were subjected to a 90-degree separation test. In all cases, the width of the separation samples was 25 mm and measurement was carried out at a separation speed of 200 ma/min. The results are shown in Table 1. In all cases using any adhesive, good separation strength of 15 N125 mm or higher was obtained.

TABLE 1

| | type of | | | |
|---|---|---|---|---|
| | adhesive | | | |
| | | | | epoxy |
| | water-based | | | ultraviolet |
| | epoxy | urethane | cyanoacrylate | curable |
| | adhesive | adhesive | adhesive | adhesive |
| 180-degree | 21.23 | 24.62 | 16.56 | — |
| separation | | | | |
| strength | | | | |
| (N/25 mm) | | | | |
| 90-degree | 15.20 | — | — | 16.15 |
| separation | | | | |
| strength | | | | |
| (N/25 mm) | | | | |

### EXAMPLE 2

After a film was produced by melting and extruding the crystalline polypropylene type resin of the propylene/ethylene random copolymer same as that used in Example 1, the film was stretched by successive biaxial stretching in order to vertical stretching and transverse stretching to obtain a retardation with a thickness of 21 μm and Ro=60 nm and Rth=115 nm. A polarizer comprising a protection layer of a triacetyl cellulose film stuck to one face of a polyvinyl alcohol/iodine type polarizer was prepared and the retardation film obtained in the above-mentioned manner was stuck to the polarizer face by the water-based epoxy adhesive described in Example 1 to obtain a composite polarizing plate. The thickness of the composite polarizing plate was 122 μm and was thus made thinner than that of a polarizer obtained by sticking a protection layer of a 80 μm-thick triacetyl cellulose film to both face of the polarizer. If a 40 μm-thick triacetyl cellulose film was used, the thickness of the composite polarizing plate could be made thin to 82 μm.

### EXAMPLE 3

After a film was produced from the same propylene/ethylene random copolymer as that used in Example 1, successive biaxial stretching was carried out to obtain a biaxial retardation film. This retardation film has R0=55 nm and Rth=115 nm. Corona discharge treatment was carried out for the surface of this retardation film. The corona discharge treated-face of the retardation film was stuck to one face of a polyvinyl alcohol/iodine type polarizer and a triacetyl cellulose film treated by saponification was stuck to the other face of the polarizer using the water-based epoxy adhesive shown in Example 1 and thereafter, drying at 80° C. for 5 minutes was carried out and curing at 40° C. for about 60 hours was carried out to obtain a composite polarizing plate. At that time, the absorption axis of the polarizer and the delay-phase axis of the retardation film were arranged to be rectangular each other.

Next, “BRAVIA 32”, a liquid crystal television, manufactured by Sony was disassembled and the polarizing plates in the upper and lower sides of the liquid crystal cell were separated and the obtained composite polarizing plate was stuck to the polypropylene type retardation film side with a pressure sensitive adhesive in place of the original polarizing plates. The layer configuration and axial relation in this case is as shown in FIG. 2. After again a television was assembled and a back light was turned on, the contrast change in accordance with the field angle was measured by “ZE Contrast 88XL”, a liquid crystal field angle measurement apparatus manufactured by ELDIM and the equivalent contrast curve is shown in FIG. 3.

In FIG. 3, the right direction in the view was set to 0.0 degree and the azimuth angle is displayed while the contra-clockwise rotation is set to be right (numerals are shown every 45 degree from 0 degree to 315 degree) and also the indications “10”, “20”, . . . “80” mean the tilting angles to the normal lines at the azimuth angles. For example, the right end of the circle is at 0 degree as the azimuth angle and has contrast in the direction tilting approximately 90 degrees from the normal line and the center of the circle has 0-degree inclination, that is, it means contrast in the normal line of the screen. The contract is the ratio of the luminance at the time of white display (voltage application to the liquid crystal cell) to the luminance at the time of black display (no voltage application to the liquid crystal cell).

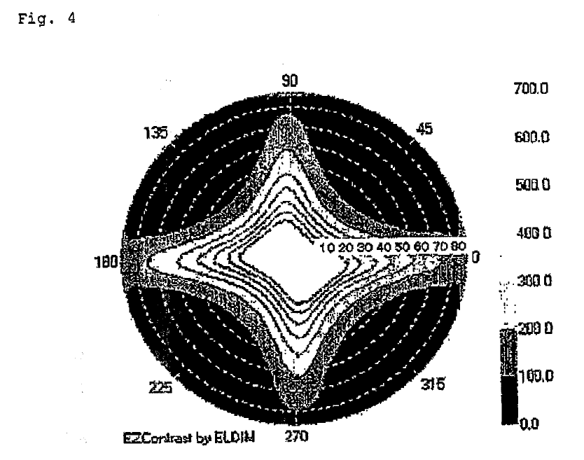

On the other hand, the equivalent contrast curve of “BRAVIA 32” itself (before disassembly), a liquid crystal television, employed here is shown in FIG. 4. As being understood from FIGS. 3 and 4, the composite polarizing plate produced in this Example exhibited equal to or higher capability than that of the actual product (FIG. 4).

The composite polarizing plate of the invention scarcely shows size change due to the temperature fluctuation and is thus excellent in the size stability. Further, since a polypropylene type resin is used for the retardation film composing the composite polarizing plate, a desired retardation value can be exhibited for a thin thickness. Further, adhesion of the retardation film of the polypropylene type resin and the polarizer can be done by conventionally known adhesives containing epoxy type resins and urethane type resins as components and accordingly good adhesion property can be obtained. In addition, since the retardation film is made of the polypropylene type resin, the cost can be remarkably lowered as compared with the costs of conventional retardation films specified for optical uses and it is also one of significant advantages.

What is claimed is:

1. A composite polarizing plate comprising a transparent protection layer on one face of a polarizer made of a polyvinyl alcohol resin, and wherein a retardation film made of a polypropylene resin is adhered to the other face of the polarizer opposite to the transparent protection layer.

2. The composite polarizing plate according to claim 1, wherein the retardation film is composed of a copolymer of propylene and ethylene containing 10% by weight or less of ethylene unit.

3. The composite polarizing plate according to claim 1, wherein the retardation film is obtained by biaxially stretching a raw film obtained by extrusion-molding of a polypropylene resin.

4. The composite polarizing plate according to claim 1, wherein the retardation film has an in-plane retardation value (R0) in a range of 40 to 500 nm and a retardation value (Rth) in the thickness direction in a range of 20 to 500 nm.

5. The composite polarizing plate according to claim 1, wherein the retardation film has a thickness of 5 to 60 μm.

6. The composite polarizing plate according to claim 1, wherein the retardation film and the polarizer are adhered with a water-based adhesive.

7. The composite polarizing plate according to claim 6, wherein the water-based adhesive contains a crosslinkable epoxy resin.

8. The composite polarizing plate according to claim 1, wherein the retardation film and the polarizer are adhered with a solvent-free type epoxy adhesive.

9. The composite polarizing plate according to claim 8, wherein the solvent-free type epoxy adhesive is curable by cationic polymerization by heating or irradiating an active energy ray.

10. A liquid crystal display obtained by laminating the composite polarizing plate according to any one of claims 1 to 9 to at least one side of liquid crystal cells
